(19) United States
(12) Patent Application Publication
(10) Pub. No.: US 2025/0302585 A1
(43) Pub. Date: Oct. 2, 2025

(54) DENTAL MATRIX

(71) Applicant: Marshall Hanson, Draper, UT (US)

(72) Inventor: Marshall Hanson, Draper, UT (US)

(21) Appl. No.: 18/619,128

(22) Filed: Mar. 27, 2024

(51) Int. Cl. A61C 5/85; A61C 19/04

(52) U.S. Cl. CPC A61C 5/85; A61C 19/04

(57) ABSTRACT

There is a mylar matrix band. The mylar matrix band has an elongated thin plastic film having an overall shape of an inverted-V with a flattened middle, and including three regions, specifically: a middle region having a primary axis along a horizontal extent thereof; a left region adjacent to the middle region and extending at a first angle from the primary axis of the middle region; and a right region adjacent to the middle region opposite the left region and extending at a second angle from the primary axis of the middle region; wherein the first and second angles are between 25-60 degrees from the primary axis and an interior length of the middle region as measured from an interior transition between each of the left region and right region is greater than 5 mm.

### BACKGROUND OF THE INVENTION

### Field of the Invention

The present invention relates to dental repair work and devices, specifically dental matrixes for repairing teeth.

### Description of the Related Art

In the related art, it has been known to use mylar matrix bands to fill teeth. A dental matrix is typically used by dentists to retain packed filling material in position within a tooth prepared cavity. Such devices have been in use for a considerable time. Matrix bands are extensively used by dentists to fill cavitations which open through any of the vertical surfaces of a tooth. Such bands are applied circumferentially about the crown of a tooth with the lateral dimension or width of the band extending from the cervical toward the occlusal surfaces of the tooth. Once in place, the band is placed under hoop stressing by a retaining appliance to provide a dam-like mold against which a filling material may be compacted.

One of the difficulties encountered by dentists when filling an interproximal cavity (a cavity that develops on the side of a tooth) is in securing the filling material within the cavity during the curing time for the filling material. Typically, a dental matrix device is used to retain filling material within the cavity while the filling material hardens or is cured. If the matrix is not securely stabilized or aligned, the matrix can be inadvertently moved by the patient or dentist during the procedure. Any movement of the matrix from its interproximal position is likely to allow the filling material to flow outside the cavity preparation, or create a void in the filling material.

Further, often matrix bands do not intimately fit along teeth for improving gum and tooth health for aesthetics and longevity. Generally, if the shape and size of a matrix band matches the anatomical and biological shape of a tooth above the gum line, and the angle at which the gum connects to the tooth in between the teeth, then the matrix band may be custom-fit to a particular tooth. For example, if the shape and size of a band follows the cementoenamel junction of a particular tooth, then the band should fit intimately along the tooth.

The cementoenamel junction represents the anatomic limit between the crown and root surface and is defined as the area of union of the cementum and enamel at the cervical region of the tooth. This junction plays an important part in protecting different areas of a tooth and keeping it healthy over time. Accordingly, it is important that a matrix band fit snugly and securely along a tooth to achieve optimal results when compacting filling material.

Some improvements have been made in the field. Examples of references related to the present invention are described below in their own words, and the supporting teachings of each reference are incorporated by reference herein:

European Patent No: EP0470552A1, issued to Jouko, discloses the dental matrix (1) has at least one transparent area and permits, by virtue of its design, the optimization of the marginal adaptation of approximal edge areas of photo-cured MO, OD and MOD composite restorations.

U.S. Pat. No. 4,536,155, issued to Ireland, discloses an improved dental matrix band of the general type having a central tooth circumscribing portion extending between cervical and occlusal edges and merging with a pair of arms adapted for engagement by a retainer appliance and to which a leaf-like flap is secured to the tooth engaging surface of the band to be deformable away from the band by a compressible wedge against the surface of a tooth to be filed. The flap has an inner edge generally coextensive with the cervical edge of the band and extends to an outer edge coextensive with or beyond the occlusal edge of the band. The flap is secured at only one corner either by a pair of spotwelds to leave remaining the major area of the flap to be deflectable against the surface of a tooth. Alternatively, the flap is secured by a bendable neck portion integral with both the flap and the band.

U.S. Pat. No. 5,035,615, issued to Din, discloses a dental matrix band that is flexible and bondable to resin based restorative materials. This matrix band will permanently bond to the filing and the tooth. It becomes a permanent part of the composite restoration and may be wholly retained, partially retained, or completely removed depending upon the needs of the dentist, patient and the specific purpose for which this band is used. The dentist forms a prepared cavity. The thin, flexible composite matrix band is then inserted between the tooth and the adjacent tooth. The band is firmly held against the tooth with the surface of the band passively abutting the adjacent tooth. A bonding agent is applied to the appropriate tooth surfaces, the cavity and the band. The agent is cured, the prepared cavity is filed with a composite resin, the resin is cured, and the excess portion of the band is removed.

U.S. Pat. No. 6,619,956, issued to Weir, discloses an elongated flexible dental matrix strip is disclosed. The strip includes a raised portion extending outward from the surface of the strip. The raised portion tapers towards the distal end of the strip in one embodiment and tapers toward both ends of the strip in another embodiment. The raised portion is sized so that when the strip is inserted between adjacent teeth an interference fit occurs. A light force is used to slide the strip into position between adjacent teeth in such a fashion as to anchor the strip in position. The strip serves to contain filing material in a tooth cavity while the filing material or resin hardens. Another embodiment includes a curved surface along one edge of the strip where in the raised tapered portion is disposed. Yet another embodiment includes two raised tapered portions in parallel with one another.

U.S. Pat. No. 3,842,505, issued to Eames, discloses a dental matrix band construction of the type including a central tooth-surrounding portion with arms formed at the opposite end of the tooth-surrounding portion. These arms are utilized for securing the band in position on a tooth. The central portion of the band defines a concave interior to the engaging surface because of a bend in the upper part thereof, the concavity extending between the top and bottom edges of the central portion. The bottom edge of the band defines a straight edge while the top edge of the band is curved between the respective junctures of the arms and central portion whereby the band is progressively wider from the junctures to the mid-point of the central portion.

U.S. Pat. No. 5,620,322 issued to Lococo, discloses a dental matrix of the type of a flexible strip, preferably made from a thin, strong, flexible material such as Mylar™. Instead of the usual rectangular band, the strip tapers toward one end to provide a variety of sections having different widths so that the overlap of a cavity, usually in the inter proximal surface of a tooth, can be accurately made by simply sliding the strip to a desired position. As a result, there is an improved strength with which the strip envelopes the immediate vicinity of the filed cavity thus preventing undesired escape of the filing material towards the gum or towards the incisive part of the tooth. Two embodiments are disclosed.

The inventions heretofore known suffer from a number of disadvantages which include: being difficult to use, not having a large enough interior angle, not including markings for orientation, not being durable, not being customizable, being more expensive, not fitting well, not having an accurate design, not using specific and/or biologic measurements, not being easy to shape, being more rigid, not being transparent, being less adaptable, being made of metal, not being natural looking, being less healthy, and having less strength.

What is needed is a mylar matrix band that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available mylar matrix bands. Accordingly, the present invention has been developed to provide a mylar matrix band for repairing teeth.

In one embodiment of the invention, the mylar matrix band may comprise an elongated thin plastic film that may have an overall shape of an inverted-V with a flattened middle, and including three regions. The three regions may be: a middle region that may have a primary axis along a horizontal extent thereof; a left region that may be adjacent to the middle region and/or may extend at a first angle from the primary axis of the middle region; and/or a right region that may be adjacent to the middle region opposite the left region and/or that may extend at a second angle from the primary axis of the middle region. The first and/or second angles may be between 25-60 degrees from the primary axis and/or an interior length of the middle region as measured from an interior transition between each of the left region and/or right region is greater than 5 mm.

In another embodiment, the mylar matrix band may further comprise a central marking that may be disposed near a center of the flattened middle of the inverted-V. The mylar matrix band may also further comprise an orientation indicator that may be disposed lateral to the central marking with respect to the center of the flattened middle. In one embodiment, the central marking may be a dashed line. The dashed line may have a thickness of 0.01 to 0.02 mm.

In yet another embodiment, the central marking may be disposed 1 mm from the center of the flattened middle. The band may be colored such that a color of the band may indicate a size of the band. The left region and/or the right region may be symmetrical and/or may have a same length. The left region and/or the right region may not be symmetrical and/or may have different lengths. The orientation indicator may be a branding mark.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a front perspective view of a mylar matrix band, showing the mylar matrix band in use and disposed about a tooth, according to one embodiment of the invention;

FIG. 2 is a top plan view of a mylar matrix band, showing the mylar matrix band not in use, according to one embodiment of the invention;

FIG. 3 is a top plan view of a mylar matrix band, showing the mylar matrix band not in use and showing markings disposed on the mylar matrix band, according to one embodiment of the invention;

FIG. 4 is a front perspective view of a mylar matrix band, showing the mylar matrix band in use, according to one embodiment of the invention;

FIG. 5 is a top plan view of a mylar matrix band, showing the mylar matrix band not in use, according to one embodiment of the invention; and

FIG. 6 is a top plan view of a mylar matrix band, showing the mylar matrix band not in use, according to one embodiment of the invention.

### DETAILED DESCRIPTION OF THE INVENTION

For the purpose of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

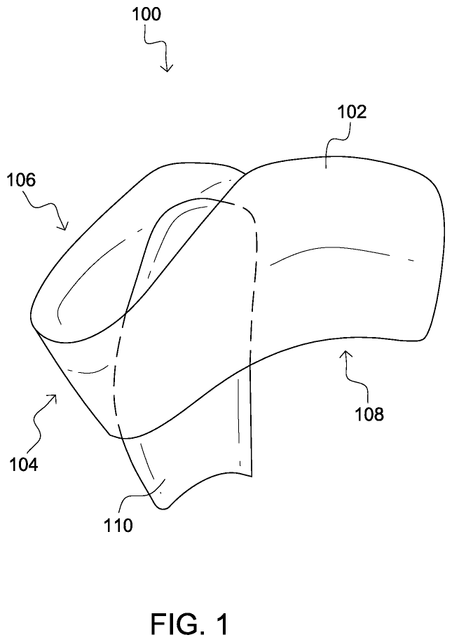

FIG. 1 illustrates a front perspective view of a mylar matrix band, showing the mylar matrix band in use and disposed about a tooth, according to one embodiment of the invention. There is shown a mylar matrix band 100 that may be an elongated thin plastic film 102. The elongated thin plastic film 102 includes a middle region 104 that is flanked by a left region 106 and a right region 108.

The illustrated mylar matrix band 100 may be comprised of plastic. The mylar matrix band 100 may be an elongated thin plastic film 102. The mylar matrix band 100 may be thin and flexible for disposal between teeth 110 and/or wrapping around teeth 110. The mylar matrix band 100 may wrap around teeth 110 and form a barrier or shield for said teeth 110. The elongated thin plastic film 102 may have any thickness for flexibility and/or positioning between and/or around teeth 110.

As illustrated, the middle region 104, the left region 106, and the right region comprise the mylar matrix band 100. The illustrated middle region 104 may be a straight section, and the left region 106 and the right region 108 may both be curved. The middle region 104, the left region 106 and the right region 108 may be sized and/or shaped for placing around a tooth 110. For instance, in one non-limiting embodiment, the left region 106 and the right region 108 may each have a width of about ten millimeters. The mylar matrix band 110 may have any length for circumferential disposal about a tooth 110.

In one embodiment of the invention, the matrix band(s) may be custom fit for each tooth based on biologic measurements. For instance, the matrix band(s) may have different shapes and sizes customized to the tooth they are being used for. Accordingly, the matrix band(s) may be part of a system of measuring a particular tooth that is being worked on a custom fitting a matrix band to that particular tooth for a very intimate and perfect seal around the tooth, thereby improving gum and tooth health for aesthetics and longevity.

In operation of one embodiment of the invention, there is a uniquely shaped clear strip used as a matrix band that inserts into gums and seals at the bottom of a solcus and wraps around a tooth and slides between teeth to create a seal below the gum. The matrix band is also stabilized in between the teeth and is custom-fit for each person and each tooth. The matrix band allows composite to be placed onto a tooth and creates a perfectly smooth finish line along gums, while also allowing the composite to be strong enough to function and have a volume to create a natural-looking tooth thereby providing aesthetics and longevity of the composite.

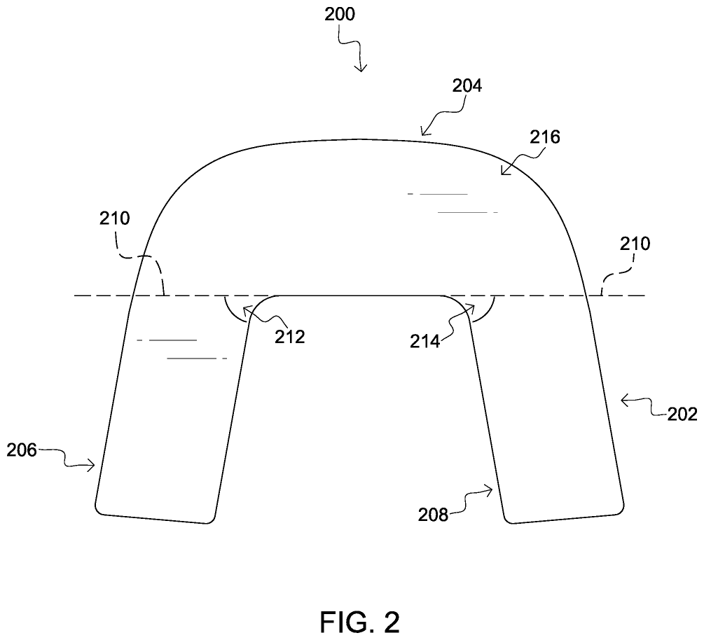

FIG. 2 illustrates a top plan view of a mylar matrix band, showing the mylar matrix band not in use, according to one embodiment of the invention. There is illustrated a mylar matrix band 200 that may be an elongated thin plastic film 202. The mylar matrix band has a middle region 204, a left region 206 coupled to the middle region 204 and extending therefrom, and a right region 208 coupled to the middle region 204 and extending therefrom opposite the left region 206. The illustrated middle region 204 includes a primary axis of middle region 210 along a horizontal extent thereof.

As shown, the elongated thin plastic film 202 has an overall shape of an inverted-V with a flattened middle. The elongated thin plastic film 202 may be comprised of any material to allow for flexibility and bending of the elongated thin plastic film 202. For instance, the elongated thin plastic film 202 may be comprised of materials such as plastic and other polymers. More, the elongated thin plastic film 202 may have any overall shape to allow for wrapping around a tooth. For example, the elongated thin plastic film 202 may be U-shaped, C-shaped, brace-shaped, bracket-shaped, parenthesis-shaped, and so on.

In addition, the elongated thin plastic film 202 includes three specific regions: a middle region 204, a left region 206, and a right region 208. The illustrated middle region 204 includes a primary axis along a horizontal extent thereof 210. Adjacent to the middle region 204 is a left region 206. The left region 206 extends at a first angle 212 from the primary axis 210 of the middle region 204. The right region 208 is adjacent to the middle region 204 opposite the left region 206. The right region 208 extends at a second angle 214 from the primary axis 210 of the middle region 204. The illustrated left region 206 and right region 208 may extend at any angle from the middle region 204. In one embodiment, the first angle 212 and the second angle 214 may each be between twenty-five and sixty degrees from the primary axis 210 and an interior length 216 of the middle region 204 as measured from an interior transition between each of the left region 206 and right region 208 and is greater than five millimeters.

In one non-limiting embodiment, the angles range from 25-60 degrees. The angles may be outside this range, but 25-60 degrees is preferable for positioning and sealing to a gumline. In one embodiment, the first angle 612 and the second angle 614 may be arced, bowed, or curved. The mylar matrix band 200 may be sized and shaped to fit and repair an incisor. Additionally, the mylar matrix band 200 may have angles outside of this range to fit different teeth such as incisors, cuspids, and bicuspids.

In another non-limiting embodiment of the invention, the angles may be designed to follow the cementoenamel junction of a particular tooth. For example, the angles may be based on measurements taken from actual human teeth. Because these angles may match the anatomical and biological shape of the tooth above the gum line, and the angle at which the gum connects to the tooth in between the teeth, it allows the matrix band(s) to truly and intimately custom-fit to a particular tooth. The middle region may also be customized. The length of the middle region, and therefore the length of a primary axis along a horizontal extent thereof, may be measure and paired with a measurement along a front of a tooth to contribute to the matrix band's intimate fit around a tooth in a customized fashion.

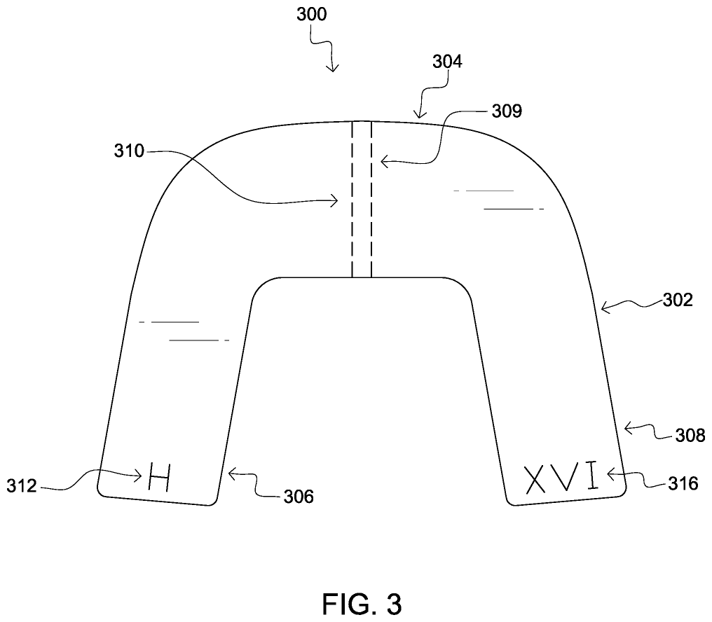

FIG. 3 illustrates a top plan view of a mylar matrix band, showing the mylar matrix band not in use and showing markings disposed on the mylar matrix band, according to one embodiment of the invention. As shown, the mylar matrix band 300 is an elongated thin plastic film 302. The elongated thin plastic film 302 includes a middle region 304 with a left region 306 and a right region 308 each disposed on opposite sides of the middle region 304 and flanking the middle region 304. The middle region 304 is shown to include an offset marking guide 309 and a central marking 310. The mylar matrix band also includes an orientation indicator 312 and a margin length indicator 316.

In one embodiment, the illustrated elongated thin plastic film 302 may be transparent so that the central marking 310, the orientation indicator 312, and the margin length indicator 316 may be viewed from either a front side or a back side of the elongated thin plastic film 302. In addition, the elongated thin plastic film 302 may be colored, include a colored portion, or have a colored marking to indicate a size of the elongated thin plastic film.

The illustrated central marking 310 is disposed on the middle region 304. The orientation indicator 312 may be disposed on the middle region 304 or the left region 306. The central marking 310 disposed near a center of the flattened middle of the inverted-V. For instance, the central marking 310 may be disposed one millimeter from the center of the flattened middle of the middle region 304.

Further, the central marking 310 is shown as a dashed line, but may be any type of central indicator, such as a full line, a line segment, a fold, or any other design. More, the central marking 310 may have any thickness. In one non-limiting embodiment, the central marking 310 may have a thickness of 0.01 to 0.02 millimeters.

The illustrated orientation indicator 312 may indicate an orientation of the mylar matrix band 300. The orientation indicator 312 may indicate a front, back, top, bottom, left, or right, etc. of the mylar matrix band 300. As shown, the orientation indicator 312 may be a letter, or an initial, but the orientation indicator 312 may be any shape or symbol or have any design for indicating orientation. In one embodiment, the orientation indicator 312 may be a branding mark and may indicate distal orientation.

More, the illustrated margin length indicator 316 may indicate a margin length. The margin length indicator 316 may be a number or another type of indicator such as a color, or a roman numeral or cardinal number. The margin of length indicator 316 may also be a symbol or a shape.

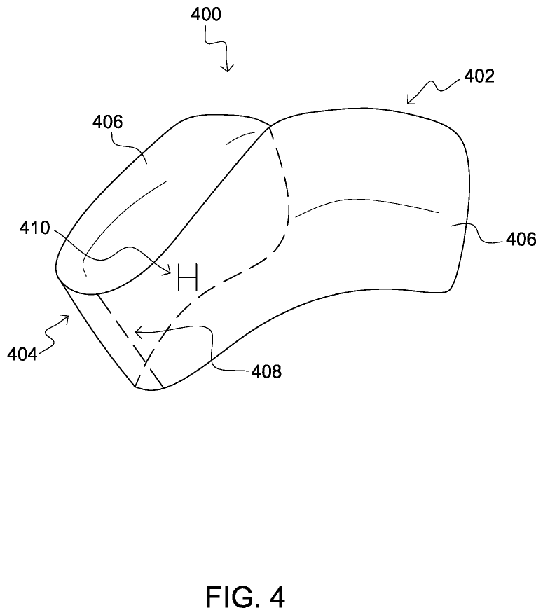

FIG. 4 illustrates a front perspective view of a mylar matrix band, showing the mylar matrix band in use, according to one embodiment of the invention. There is illustrated a mylar matrix band 400 that is an elongated thin plastic film 402. The mylar matrix band includes a central portion 404 with two wings 406 disposed about the central portion 404 and extending therefrom. There is also a central marking 408 and an orientation indicator 410 each disposed on the central portion 404.

As shown, the central portion 404 may be such as the middle region shown in FIG. 1, item 104. The two wings 406 may be such as the left region and the right region shown in FIG. 1, items 106 and 108, respectively. Accordingly, the two wings 406 are horizontal structures that project from both sides of the central portion 404. As such, the two wings 406 may support the central portion 404 as well as the entire mylar matrix band 400 while in use.

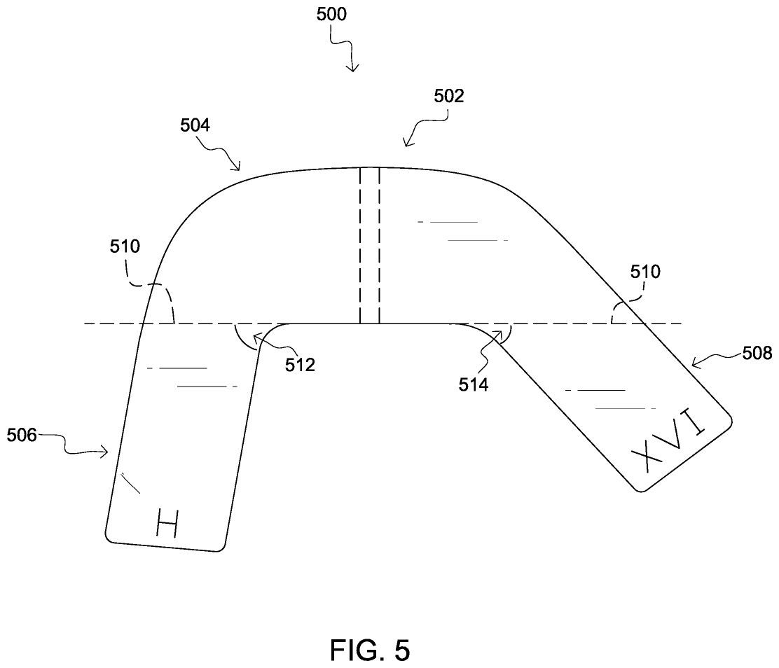

FIG. 5 illustrates a top plan view of a mylar matrix band, showing the mylar matrix band not in use, according to one embodiment of the invention. As shown, there is a mylar matrix band 500. The mylar matrix band 500 may be an elongated thin plastic film 502 with: a middle region 504, a left region 506, and a right region 508.

The illustrated middle region 504 includes a primary axis along a horizontal extent thereof 510. The left region 506 extends at a first angle 512 from the primary axis 510 of the middle region 504. The right region 508 is adjacent to the middle region 504 opposite the left region 506. The right region 508 extends at a second angle 514 from the primary axis 510 of the middle region 504.

The illustrated first angle 512 and second angle 514 may be identical or they may be different. The first angle 512 and/or second angle 514 may be acute, right, and/or oblique. In one non-limiting embodiment of the invention, the first angle 512 and the second angle 514 may each measure between twenty-five and sixty degrees. In one non-limiting embodiment, the mylar matrix band 500, including the angles 512 and 514, may be sized and/or shaped to fit for repair of a cuspid, bicuspid, premolar, and/or molar.

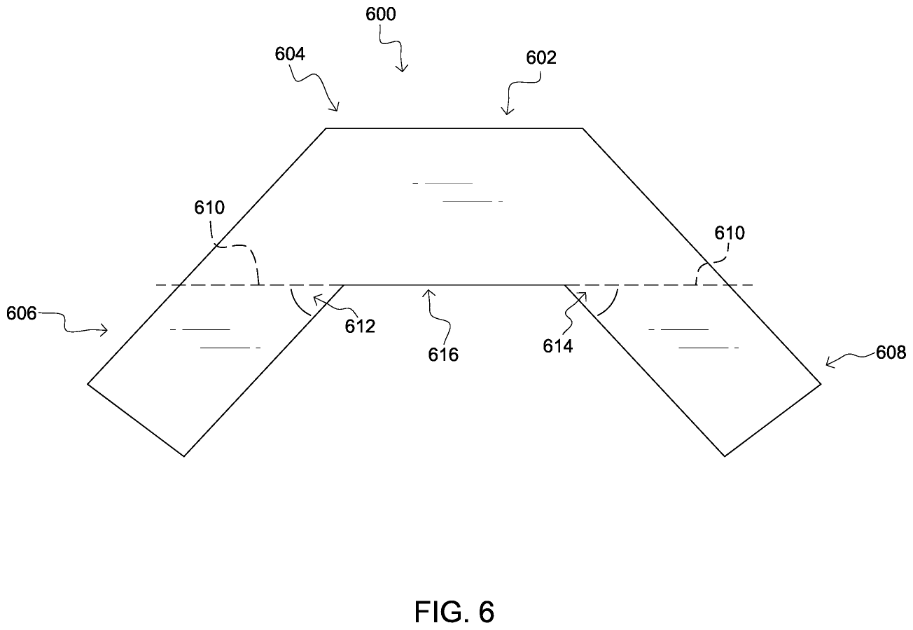

FIG. 6 illustrates a top plan view of a mylar matrix band, showing the mylar matrix band not in use, according to one embodiment of the invention. There is illustrated a mylar matrix band 600. The mylar matrix band may be an elongated thin plastic film 602. The mylar matrix band 600 has a middle region 604, a left region 606, and a right region 608.

As shown, the middle region 604 has a primary axis 610 along an interior length 616 of the middle region. The left region 606 extends at a first angle 612 from the primary axis 610 of the middle region 604. The right region 608 is adjacent to the middle region 604 opposite the left region 606. The right region 608 extends at a second angle 614 from the primary axis 610 of the middle region 604. The first and second angles 612 and 614 may be identical or the first angle 612 may be larger than the second angle 614 or vice versa. In one non-limiting embodiment, the mylar matrix band 600 may be sized and/or shaped to fit for repair of a tooth.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, the mylar matrix band and its components may vary in thickness, widths, lengths, and type of material. The mylar matrix band may have regions extending at different ranges of angles. It may or may not have markings.

Additionally, although the figures illustrate a single mylar matrix band, the bands may be offered in kits or packages of five or any number. It is also envisioned that kits and packages may include mylar matrix bands of different sizes. For example, as a width of the middle region, or central portion increases, a length of the left and right regions, or wings, may also increase. Alternatively, as a width of the middle region, or central portion increases, a length of the left and right regions, or wings, may remain the same. Accordingly, the bands may be offered in kits to fit different teeth such as incisors, cuspids, and bicuspids.

It is expected that there could be numerous variations of the design of this invention. An example is that the left and right regions, or wings, may have different or identical sizes and/or shapes. Further, in non-limiting embodiments, the left and right regions, or wings, may have a width of about six to about twenty millimeters. The left and right regions, or wings, may have a length of about twenty millimeters, but the length may vary in size depending on a size of a patient's mouth and/or comfort level. More, the mylar matrix may have a thickness of about two one thousandths of an inch or maybe somewhere between two one thousandths of an inch and three one thousandths of an inch.

Finally, it is envisioned that the components of the device may be constructed of a variety of materials, such as but not limited to plastics and/or other polymers and/or other flexible and/or transparent materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A mylar matrix band, comprising:
a. an elongated thin plastic film having an overall shape of an inverted-V with a flattened middle, and including three regions, specifically:
i. a middle region having a primary axis along a horizontal extent thereof;
ii. a left region adjacent to the middle region and extending at a first angle from the primary axis of the middle region; and
iii. a right region adjacent to the middle region opposite the left region and extending at a second angle from the primary axis of the middle region;
b. wherein the first and second angles are between 25-60 degrees from the primary axis and an interior length of the middle region as measured from an interior transition between each of the left region and right region is greater than 5 mm.

2. The mylar matrix band of claim 1, further comprising a central marking disposed near a center of the flattened middle of the inverted-V.

3. The mylar matrix band of claim 2, further comprising an orientation indicator disposed lateral to the central marking with respect to the center of the flattened middle.

4. The mylar matrix band of claim 2, wherein the central marking is a dashed line.

5. The mylar matrix band of claim 4, wherein the dashed line has a thickness of 0.01 to 0.02 mm.

6. The mylar matrix band of claim 2, wherein the central marking is disposed 1 mm from the center of the flattened middle.

7. The mylar matrix band of claim 1, wherein the band is colored such that a color of the band indicates a size of the band.

8. The mylar matrix band of claim 1, wherein the left region and the right region are symmetrical and have a same length.

9. The mylar matrix band of claim 1, wherein the left region and the right region are not symmetrical and have different lengths.

10. The mylar matrix of claim 3, wherein the orientation indicator is a branding mark.

11. A mylar matrix band, comprising:
a. a clear mylar strip having:
i. a central marking that is off-center by an off-set amount of about 1 mm, to account for a difference in mesial and distal CEJ positions, and having a line thickness of less than 10% of the off-set amount;
ii. an orientation indicator positioned or shaped on the clear mylar strip such that a visual inspection thereof allows for proper identification of a direction of offset of the central marking.

12. The mylar matrix band of claim 11, further comprising a central portion and two wings flanking the central portion and extending therefrom.

13. The mylar matrix band of claim 12, wherein the central portion is greater than 5 mm.

14. The mylar matrix band of claim 13, wherein the two wing portions extend from the central portion at an angle between 25-60 degrees from a primary axis and an interior length of the central portion.

15. The mylar matrix band of claim 11, wherein the band is colored such that a color of the band indicates a size of the band.

16. The mylar matrix band of claim 11, wherein the central marking is a dashed line.

17. The mylar matrix band of claim 16, wherein the dashed line has a thickness of 0.01 to 0.02 mm.

18. The mylar matrix band of claim 12, wherein the wings are symmetrical and have a same length.

19. The mylar matrix of claim 11, wherein the orientation indicator is a branding mark.

20. A mylar matrix band kit, for color-coding lengths of mylar strips, comprising:
a. a first clear mylar strip, including a central portion and two wings flanking the central portion and extending therefrom, and having:
i. a central marking that is off-center by an off-set amount of about 1 mm, to account for a difference in mesial and distal CEJ positions, and having a line thickness of less than 10% of the off-set amount;
ii. an orientation indicator positioned or shaped on the clear mylar strip such that a visual inspection thereof allows for proper identification of a direction of offset of the central marking; and
iii. a first color indicating a first strip length; and
b. a second clear mylar strip, including a central portion and two wings flanking the central portion and extending therefrom, and having:
i. a central marking that is off-center by an off-set amount of about 1 mm, to account for a difference in mesial and distal CEJ positions, and having a line thickness of less than 10% of the off-set amount;
ii. an orientation indicator positioned or shaped on the clear mylar strip such that a visual inspection thereof allows for proper identification of a direction of offset of the central marking; and
iii. a second color indicating a second strip length.
